(19) United States
(12) Patent Application Publication
(10) Pub. No.: US 2011/0076541 A1
(43) Pub. Date: Mar. 31, 2011

(54) BATTERY

(75) Inventors: Jens Meintschel, Bernsdorf (DE); Dirk Schroeter, Winnenden (DE)

(73) Assignee: Daimler AG, Stuttgart (DE)

(21) Appl. No.: 12/672,039

(22) PCT Filed: Jul. 29, 2008
(86) PCT No.: PCT/EP08/06227

§ 371 Date: Nov. 30, 2010

(30) Foreign Application Priority Data
Aug. 6, 2007 (DE) 10 2007 036 845.5
Dec. 20, 2007 (DE) 10 2007 063 185.7

(51) Int. Cl. H01M 10/50

(52) U.S. Cl. 429/120

(57) ABSTRACT

A battery comprising a plurality of individual cells that are formed by heat conducting reciprocal housing plates that are positioned at a distance from each other at least in sections so as to form fluid-permeable flow-through channels. A fluid flow guiding unit is disposed on at least one edge side of the individual cell housing of each individual cell.

This application is a national stage of PCT International Application No. PCT/EP2008/006227, filed Jul. 29, 2008, which claims priority under 35 U.S.C. §119 to German Patent Application No. 10 2007 036 845.5, filed Aug. 6, 2007 and No. 10 2007 063 185.7, filed Dec. 20, 2007, the entire disclosures of which are herein expressly incorporated by reference.

### BACKGROUND AND SUMMARY OF THE INVENTION

The invention relates to a battery with several individual cells, wherein the housing walls which preferably conduct heat well of adjacent individual cells are spaced from each other at least in regions in a manner of forming fluid-permeable flow-through channels as is for example known and used in the energy technology, especially in the at least supporting battery-operated vehicle technology.

For temperature control, preferably for cooling of several individual batteries arranged within a battery box, it is known to arrange their housings spaced from each other, so that a fluid can flow through flow-through channels formed by the housing walls. This fluid is in a heat-conducting contact with these housing walls, so that a temperature control of the individual batteries through the fluid is enabled.

High performance batteries, for example lithium ion cells for so-called mild hybrid vehicles have to be cooled intensely to discharge the resulting lost heat. An indirect cooling supported by a fluid through the air conditioning cycle or a direct cooling by means of a precooled fluid, preferably air, which is guided between the cells, is advantageous.

For guiding the fluid flow through the intermediate cell space, special guide plates and baffles are used up to now. These are elaborate with regard to installation space and expensive.

One object of the invention is to provide a battery for which costs and installation space requirements are reduced.

This and other objects and advantages are achieved by the battery according to the invention, with several individual cells whose housing walls efficiently conduct heat of adjacent individual cells, and are spaced from each other at least in regions so as to form fluid-permeable flow-through channels. It has a fluid flow guiding unit at least one edge of an individual cell housing of an individual cell. By arrangement of a fluid flow guiding unit at least one edge region of an individual cell housing of an individual cell, guiding plates (which were conventional up to now and had to be introduced additionally), are omitted, as they can already be arranged during the production of the individual cells at their housings in a simple and cost-efficient manner. As additional constructive holding and/or adjusting elements are furthermore omitted, the costs are also reduced further. The required installation space is also reduced.

For improving the flow behavior of the fluid and thus for the more effective cooling, a deflection wall of the fluid flow guiding unit, which deflects the inflowing fluid into a flow-through channel, is bent away from the flow-through direction of the flow-through channels in an advantageous further development of the invention (namely in the direction of the inflowing fluid, that is, in the opposite flow direction).

The deflection wall of the fluid flow guiding unit has to be formed rounded in an especially advantageous manner, preferably in the form of a quarter circle, whereby the flow is resistance-free to a higher extent.

In an advantageous further development of the invention, the housings of the individual cells are formed in a prismatic, especially cuboidal manner. This results in a simple housing which can be manufactured in a simple and cost-efficient manner. Additionally, a simple and secure fixing is enabled at the bottom side and also at the edge side. Such a housing is especially safe from vibrations and can be stacked easily. The installation space can also be used optimally. A stable position of the individual cells by a possible planar arrangement or pressing to each other is additionally given.

For reasons of space, and also efficiency and at least uniformity of temperature control of the inner regions of the battery, the individual cells are cuboidal in an advantageous further development of the invention, wherein the length of the broadsides of an edge side having the fluid flow guiding unit is at least five, preferably at least ten, and especially preferred at least twenty times the length of the narrow side of the individual cell.

In an advantageous further development of the invention for the formation of the fluid flow guiding unit, at least one (preferably the front) housing wall of an individual cell is extended and bent in the region of the flow guiding unit edge at the end towards the direction of the inflowing fluid, whereby this extension forms the fluid flow guiding unit. This enables an especially stable fluid flow guiding unit.

In an advantageous further development of the invention, the housing of an individual cell has two housing plates, which are connected at least indirectly on their edge. In this case, it is sensible amongst others that at least one (preferably the front) housing plate on the inflow side of an individual cell is formed in an extended manner and the fluid flow guiding unit is formed by this extension. This represents a housing, which is designed in a particularly simple manner, and can be produced in a simple and cost-efficient manner.

With housings having two housing plates connected to each other on the edge, at least one housing plate of two adjacent individual cells has spacers according to an advantageous further development according to the invention, which serve for forming the flow-through channel in a simple manner.

For a simple (especially punching) manufacture of the housing plates, a spacer is integrated in one of the housing plates according to a further development of the invention, wherein the spacer especially projects from its housing plate in the direction of the housing plate of an adjacent individual cell. The housing is designed in a particularly simple manner by such an integrated arrangement of a spacer and can be produced in a simple and economic manner, whereby a clear width between the housing plates is enabled in a secure manner. Additional spacers are especially avoided safely, so that the individual cells are safe from vibrations and can be stacked easily, and twisting of separate spacers, which was usual up to now encountered during assembly, is safely avoided. A good installation space usage and a stable position are additionally given by a possible planar arrangement or pressing of the individual cells to each other.

The spacers are formed as material bulges and/or protuberances and/or ridges, which are preferably driven out and/or punched out from the respective housing wall, in a manner which can be produced easily. This enables a simple housing, a simple and economic manufacture and good safety against vibrations, easy stacking and good installation space usage, and a stable position by a possible planar arrangement or pressing of the individual parts to each other. By such integrated spacers, which are formed by formations of the housing wall itself, the clear width of the flow-through channels is ensured without additional components.

The individual cells combined to form a battery are arranged within a fluid-permeable battery box in a sensible manner, which is supplied with fluid from the outside. In a convenient manner, the fluid is again removed in a defined manner from the fluid-permeable battery box. The individual cells within the battery box are advantageously especially held on their edge, advantageously at at least one edge region of the housing, which is free of the fluid flow guiding unit. This enables a largely effective and uniform temperature control of the battery, as the cooling fluid can be distributed on all individual cells in a simple and homogenous manner in a flowing manner.

In a further development of the invention, the fluid is connected at least indirectly to the heat conducting medium of an air conditioning unit (preferably of a motor vehicle) in a heat conducting manner. A heat exchanger is hereby arranged for the heat transfer between the fluid and the heat conducting medium as a special advantage. A simple construction with components already available is enabled hereby. By the use of the heat conducting medium of the air conditioning unit also as a fluid for cooling the battery, a largely effective and uniform temperature control of the battery is additionally ensured.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic perspective view of an individual cell formed as a flat cell, with a fluid flow guiding unit integrated in the individual cell housing and projecting laterally;

FIG. 2 is a schematic side view of the individual cell according to FIG. 1;

FIG. 3 is a schematic perspective view of a battery formed of several individual cells, with a fluid flow guiding unit arranged at the respective individual cell housings; and

FIG. 4 is a schematic side view of the battery according to FIG. 3 with a battery box surrounding the individual cell compound.

Corresponding parts are provided with the same reference numerals in all figures.

### DETAILED DESCRIPTION OF THE DRAWINGS

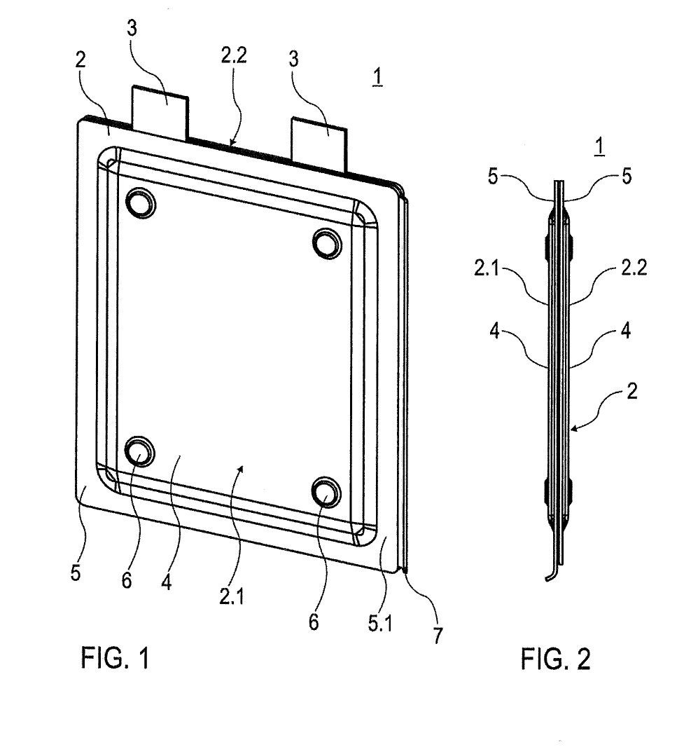

FIG. 1 shows an individual cell 1 in perspective. The individual cell 1 is thereby formed as a flat galvanic cell with an individual cell housing 2, which is especially formed of metal. The individual cell 1 is formed as a bipolar cell with respectively two housing plates 2.1 and 2.2 (housing halves corresponding to each other), which are separated by an insulator. (Differently formed galvanic individual cells 1 can also be provided.) The two housing plates 2.1, 2.2 are thereby connected on the edge at least indirectly, especially in a form-fit and possibly material-fit manner (especially, pressed or welded).

The individual cell 1 comprises vane-type extensions of the housing plates 2.1 and 2.2 (also called pole vanes) as electrical connections 3.

The respective housing plate 2.1 and 2.2 is especially formed of a thin metal sheet, in such a manner that a recess 4, which has a large area and is cuboidal or rectangular, is surrounded by an edge 5. The housing plates 2.1 and 2.2 are thereby arranged superposing each other on their edges 5, so that a hollow space is formed by their recesses 4, in which electrochemical foils with electrochemically effective materials coated with aluminum and copper foils are combined and arranged to an electrode stack (not shown). The individual electrode foils are electrically and spatially separated by a separator, preferably a foil.

The individual cell 1 is preferably designed in a prismatic and especially also in a cuboidal manner, so that it can be stacked in a simple manner. A good installation space usage and a stable position results at the same time. The length of the broadside of the individual cell housing 2 thereby has at least the fivefold, preferably at least the tenfold or especially preferred at least the twentyfold of the length of the narrow side.

For the spacing of abutting individual cells 1 during a superposed stacking, at least one spacer 6 is integrated in at least in one of the housing plates 2.1 or 2.2 or as shown in both. The spacer 6 preferably projects from the respective housing plate 2.1 or 2.2 from the bottom of the recess 4 to the outside to the abutting housing plate 2.2. or 2.1 of an adjacent individual cell 1. The spacer(s) 6 are for example formed as a material bulge, a protuberance and/or a ridge in the bottom region of the recess 4, which is driven out of, formed into, or punched into the respective housing plate 2.1 or 2.2.

For charging the outer surfaces of the housing plates 2.1, 2.2 with a cooling medium (especially cooling air or another suitable cooling medium), a fluid flow guiding unit 7 is arranged at least one edge area 5.1 of the edge 5 of at least one of the housing plates 2.1 or 2.2. The fluid flow guiding unit 7 thereby especially extends over the entire width of the edge area 5.1, wherein especially the housing side is used as an edge area 5.1 for the fluid flow guiding unit 7, which forms the broadside of the housing plate 2.1 or 2.2. An effective and efficient charging of the housing plates 2.1 or 2.2 with the cooling medium is thereby achieved.

The fluid flow guiding unit 7 is formed as an extension of the edge area 5.1 of the respective housing plate 2.1 in one possible embodiment. Alternatively, the fluid flow guiding unit 7 can be formed as a separate element, in a manner not shown in detail, and held at the edge area 5.1 or between the two housing plates 2.1 and 2.2.

The fluid flow guiding unit 7 is designed in a slightly bent or rounded manner for charging the surface of the housing plates 2.1 or 2.2 and forms a deflection wall, preferably in the form of a quarter circle for deflecting and supplying the inflowing cooling medium. The fluid flow guiding unit 7 is preferably made of metal, especially as an extension of the corresponding housing plate 2.1 itself and preferably as a bent extension of the corresponding housing plate 2.1 (thus, as a bent metal sheet). The fluid flow guiding unit 7 can made of another suitable material, especially of plastics, and be arranged, formed or molded to the edge side 5.1 or the corresponding housing plate 2.1 as a plastics molded part.

FIG. 2 shows the single cell 1 according to FIG. 1 in a side view from below.

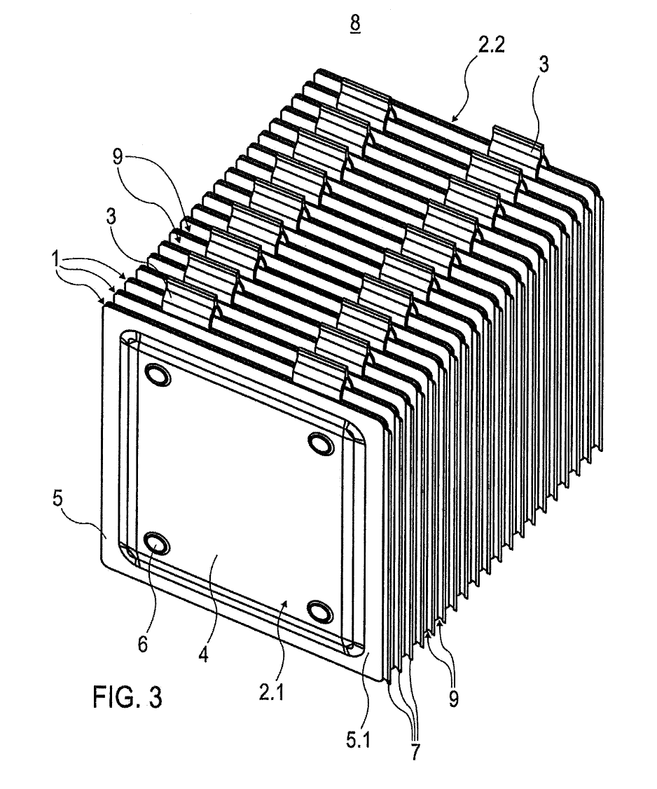

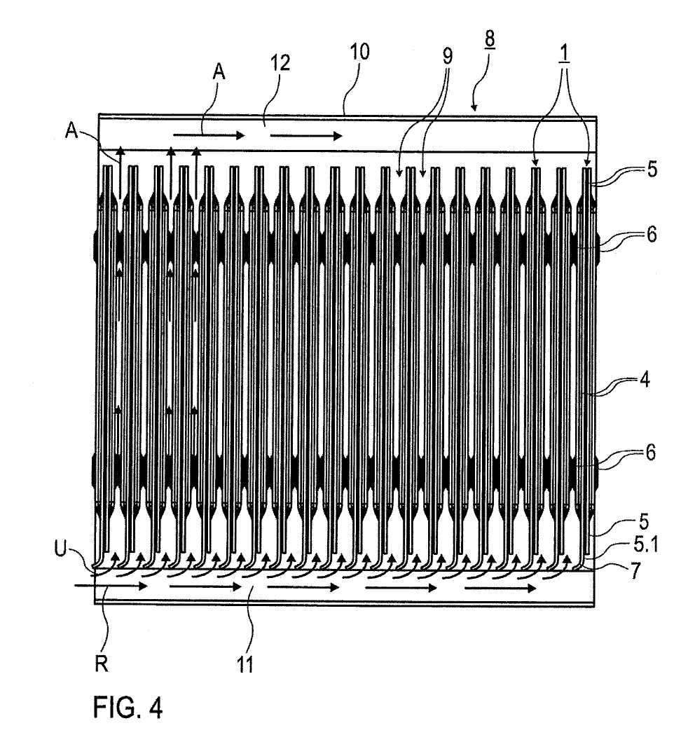

FIG. 3 is a perspective view of a battery 8 formed of several individual cells 1 (also called individual cell compound) with fluid flow guiding units 7 respectively integrated at the individual cell housing 2. The individual cells 1 are stacked above each other in a coplanar manner, wherein the electrical connections 3 of all individual cells 1 project from the individual cell housing 2 as vane-like housing extensions at the small side of the surrounding edge 5 of the housing plates 2.1 and 2.2, and the fluid flow guiding units 7 as bent or rounded housing extensions at the broad edge side 5.1 of the surrounding edge 5. Thereby, only one of the housing plates 2.1 is respectively provided with an integrated fluid flow guiding unit 7. The housing plate 2.1 of the respective individual cell 1 preferably has the fluid flow guiding unit 7, which is the front plate in the inflow direction of the fluid, especially a cooling medium, as e.g., cooling air.

The individual cells 1 are furthermore connected to each other. In one possible embodiment, the individual cells 1 can, for example, be connected via the adjacent abutting spacers 6 integrated into the housing plates 2.1, 2.2 of the respective individual cell 1 in a form-fit and material-fit manner. The individual cells 1 can alternatively be connected to each other directly or indirectly on their edge. Especially U-shaped clamp(s), not shown, is or are for example arranged on the projecting edges 5 of at least two or several or preferably all individual cells 1.

The individual cells 1 are further arranged relative to each other, in such a manner that housing plates 2.1 and 2.2 of the same polarity of two adjacent individual cells 1 abut each other; thus, their electrical connections 3 of the same polarity are connected to each other in a material-fit and form-fit manner (e.g., are welded or compressed).

For charging the surfaces of the housing plates 2.1 and 2.2 with a cooling fluid, the fluid flow guiding unit 7 deflects the inflowing fluid via the bent or rounded deflection wall into a flow-through channel 9 formed between two housing plates 2.1 and 2.2 of adjacent individual cells 1. For this, the deflection wall of the fluid flow guiding unit 7 is bent away from the flow-through direction of the flow-through channels 9 to the direction towards the inflowing fluid and is formed as a guiding plate. The fluid, especially air from the cooling channel for example of an air conditioning unit which can be connected, is thereby conveyed on the one side of the battery 8 in a specific manner into the cell intermediate space (that is, the flow-through channel 9), and is discharged therefrom on the other side of the battery 8 into the air conditioning unit or an outlet.

For improving the uniformity of the flow of the fluid, it is sensible to reduce the diameter of the inflowing cooling channel in a measure in which the fluid flows out via the flow-through channels 9. The same is valid in the reverse connection for the cooling channel receiving the outflowing fluid.

The size of the flow-through channels 9 is thereby determined by the height of the spacers 6 projecting from the bottom of the housing plates 2.1 and/or 2.2.

FIG. 4 shows the battery according to FIG. 3 in a side view. The individual cells 1 stacked to form a compound cell are thereby arranged in a battery box 10 surrounding them. The individual cells 1 are held within the battery box 10 especially on the edge, in a manner not shown in detail. The hold on the edge thereby takes place with at least one of the sides of the edge 5 at the battery box 10, which is free of the fluid flow guiding unit 7.

The individual cells 1 are arranged in the battery box 10 in such a manner that an inflow channel 11 or an outflow channel 12 for a fluid (especially a cooling fluid) is formed in a vertical extension below and above the individual cells 1 in the battery box 10.

As shown, the fluid is guided into the battery box 10 from the outside from the bottom in the flow direction R. The fluid can especially be a cooling medium, such as cooling air (especially fresh air). The fluid can alternatively be connected at least in an indirect heat conducting manner to a heat conducting medium of an air conditioning unit, preferably of a motor vehicle. A heat exchanger (not shown) is hereby provided for heat transfer between the fluid and the heat conducting medium. By the use of the heat conducting medium of the air conditioning unit also as fluid for cooling the battery 8, a highly effective and uniform temperature control of the battery 8 and the individual cells 1 is ensured.

During the operation of the battery 8, it is preferably cooled continuously or temporarily. The fluid is thereby introduced from the outside into the inflow channel 11 of the battery box 10 in the flow direction R. By means of the fluid flow guiding units 7 of the individual cells 1 integrated in the housing plates 2.1 seen in the flow direction, the fluid is deflected into the deflection flow direction U in the flow-through channels 9 formed between the individual cells 1 by means of the spacers 6. The fluid flows through the flow-through channels 9, so that the surfaces of the individual cells 1 are charged with the fluid for cooling. On the flow outlet side of the flow-through channels 9, the fluid is guided in the outlet direction A in the outlet channel 12 by means thereof to the outside e.g., into a cooling channel of an air conditioning unit, not shown.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-15. (canceled)

16. A battery comprising a plurality of individual cells, each of which has a housing with heat conducting housing walls; wherein:
the housing walls of adjacent cells are positioned at a distance from each other, in at least some areas, forming fluid-permeable flow-through channels; and
a fluid flow guiding unit is disposed on at least one edge of the housing of an individual cell.

17. The battery according to claim 16, wherein a deflection wall of the fluid flow guiding unit, which deflects an inflowing fluid into the flow-through channel is formed away from the flow-through direction of the flow-through channels in a direction towards the inflowing fluid.

18. The battery according to claim 16, wherein a deflection wall of the fluid flow guiding unit, which deflects an inflowing fluid into the flow-through channel, is formed in a rounded manner, forming a quarter circle.

19. The battery according claim 16, wherein the individual cells are prismatic.

20. The battery according to claim 16, wherein the individual cells are cuboidal.

21. The battery according to claim 20, wherein a length of a broad side of an edge area of an individual cell that includes the fluid flow guiding unit is at least the five times a length of a narrow side of the individual cell.

22. The battery according to claim 20, wherein a length of a broad side of an edge area of an individual cell that includes the fluid flow guiding unit is at least the ten times a length of a narrow side of the individual cell.

23. The battery according to claim 20, wherein a length of a broad side of an edge area of an individual cell that includes the fluid flow guiding unit is at least the twenty times a length of a narrow side of the individual cell.

24. The battery according to claim 16, wherein:
for forming the fluid flow guiding unit, at least one housing plate on the inflow side of an individual cell is extended and bent off in a region of the flow guiding unit edge area at an end towards a direction of the inflowing fluid; and
said extension forms the fluid flow guiding unit.

25. The battery according to claim 16, wherein:
the cell housing of an individual cell comprises two housing plates, which are connected to each other at an edge thereof;
at least one housing plate on an inflow side of an individual cell is elongated; and
the elongation forms the fluid flow guiding unit.

26. The battery according to claim 16, wherein:
the cell housing of an individual cell comprises two housing plates, which are connected to each other at least indirectly on their edges; and
at least one housing plate of two adjacent individual cells is provided with a spacer for forming the through-flow channel.

27. The battery according to claim 26, wherein a spacer is integrated in a housing plate.

28. The battery according to claim 27, wherein said spacer projects from the housing plate in a direction of the housing plate of an adjacent cell.

29. The battery according to claim 28, wherein said spacer comprises one of a material bulge, a protuberance, and a ridge, which is driven or punched out of the respective housing wall of the housing plate.

30. The battery according to claim 16, further comprising:
a fluid permeable battery box;
wherein the individual cells are arranged within the fluid-permeable battery box.

31. The battery according to claim 30, wherein the fluid is connected at least in an indirect heat conducting manner to a heat conducting medium of an air conditioning unit.

32. The battery according to claim 31, wherein a heat exchanger is arranged for heat transfer between the fluid and the heat conducting medium.
